(19) United States
(12) Patent Application Publication
(10) Pub. No.: US 2013/0305829 A1
(43) Pub. Date: Nov. 21, 2013

(54) METHOD FOR CONDITION MONITORING OF HYDRAULIC ACCUMULATORS

(71) Applicant: Egil Eriksen, Vassenden (NO)

(72) Inventor: Egil Eriksen, Vassenden (NO)

(21) Appl. No.: 13/991,334

(22) PCT Filed: Dec. 7, 2011
(86) PCT No.: PCT/NO11/00337

§ 371 Date: Aug. 6, 2013

(30) Foreign Application Priority Data
Dec. 8, 2010 (NO) 20101710

(51) Int. Cl. G01L 9/00

(52) U.S. Cl. CPC G01L 9/00
USPC 73/700

(57) ABSTRACT

The invention relates to a method of condition-monitoring hydraulic accumulators. The gas content of the accumulators is monitored by the gas volume being calculated on the basis of the weight and working pressure of the accumulators. The working pressure of the accumulators and a relevant operational history are recorded with an electronic logging system which stores data for use in connection with condition-based maintenance of the accumulators.

The invention relates to a method of condition-monitoring hydraulic accumulators, as defined in the preamble of the accompanying claim 1.

A hydropneumatic accumulator is a pressure vessel, normally forged out of a high-tensile alloy steel, in which liquid may be stored under pressure, with an enclosed pressurized gas volume that functions as a spring element. The accumulator is connected to a hydraulic system and when liquid is supplied to the accumulator, the gas volume is compressed by the liquid pressure rising. Thereby the accumulator can supply the system with liquid by the gas expanding as the system pressure decreases.

Accumulated hydraulic energy is commonly used as emergency power in case the supply from hydraulic pumps is lost. Accumulators are often positioned locally on equipment which is to be operated, in order to provide quick response with the necessary capacity when hydraulic functions are activated. This is common in underwater systems in which there are normally very large distances between the equipment being operated and the hydraulic power source.

There are serious safety aspects connected with a possible leak with reduction in the compressed gas volume of accumulators in some applications. An example is accumulators for hydraulically activated high-pressure barriers for safeguarding against uncontrolled blowouts from oil or gas wells during drilling or other well operations.

Corrosion may contribute to weakening the pressure vessels s over time. Piston accumulators are prone to internal wear.

Corrosion protective coating on the inside of the pressure vessel of so-called bladder accumulators may detach. Problems with corrosion and deterioration of the internal surface coating of bladder accumulators can be eliminated by the use of accumulator shells of acid-proof material, possibly composite materials.

When there is no monitoring of the gas volume, it is not possible to discover a possible leak and take preventive action until, at worst, the leak leads to problems. With monitoring is of the condition of the accumulators, a possible loss of gas from the accumulators could be registered, and with the use of corrosion-resistant pressure vessels, the need for dismantling, internal inspection and shell-testing of the accumulators could be reduced.

The prior art for monitoring the gas content in piston accumulators is measuring the position of the piston of the individual accumulator. Conventional maintenance of accumulators is preventive and based on intervals. The condition of the accumulator is checked in connection with recertification. The procedure is dismantling and internal and external inspection of the accumulators before the vessels are pressure-tested. Often, the accumulators are overhauled before the equipment is worn or the materials are deteriorated, and time and money are needlessly spent on this. With the introduction of condition-based maintenance (CBM) of accumulators, the down-time can be reduced to a minimum in consequence of efficient condition monitoring of the gas volume, and the maintenance cost may be reduced with a proper combination of continuous and planned maintenance based on the collection and processing of status information on the technical equipment. If data from the condition monitoring of the accumulators do s not indicate a need for a more extensive review of the condition and possible replacement of parts, there is a considerable economic potential in simplifying the recertification into external inspection and pressure-testing of the accumulator without dismantling.

The invention has for its object to remedy or reduce at least one of the drawbacks of the prior art, or at least provide a useful alternative to the prior art.

The object is achieved through features which are specified in the description below and in the claims that follow.

A load pin, alternatively load cells, for weighing one or more accumulators and an electronic data-logging system for measuring and storing hydraulic pressure are included in a system solution whose purpose it is to provide data for the condition monitoring of hydraulic accumulators. The total gas volume of the accumulator bank is calculated from the weight and working pressure of the accumulator bank. This is substantially different from the prior art and the method can be used for both piston and bladder accumulators.

A method of monitoring the content of compressed gas in accumulators and thereby detecting a possible leak is provided, so that the replacement or overhaul of the accumulators may be planned. By the method according to the invention, operational data are also provided to determine the need of over-hauling in connection with recertification.

The present application relates to a method of monitoring gas content in accumulators by the overall gas volume being calculated from measurements of the weight of the accumulator bank and the hydraulic pressure in the accumulators.

Another aspect of the invention is the use of a pressure logger to register the operating time and whether the operating pressure has possibly exceeded the maximum allowable working pressure of the accumulators.

The invention relates, more specifically, to a method of condition-monitoring hydraulic accumulators, characterized by the gas content of the accumulators being monitored by the gas volume being calculated on the basis of the weight and working pressure of the accumulators, and by data for the working pressure of the accumulators and a relevant operational history being collected and stored by means of an electronic logging system.

In what follows is described an example of a preferred embodiment which is visualized in the accompanying drawings, in which:

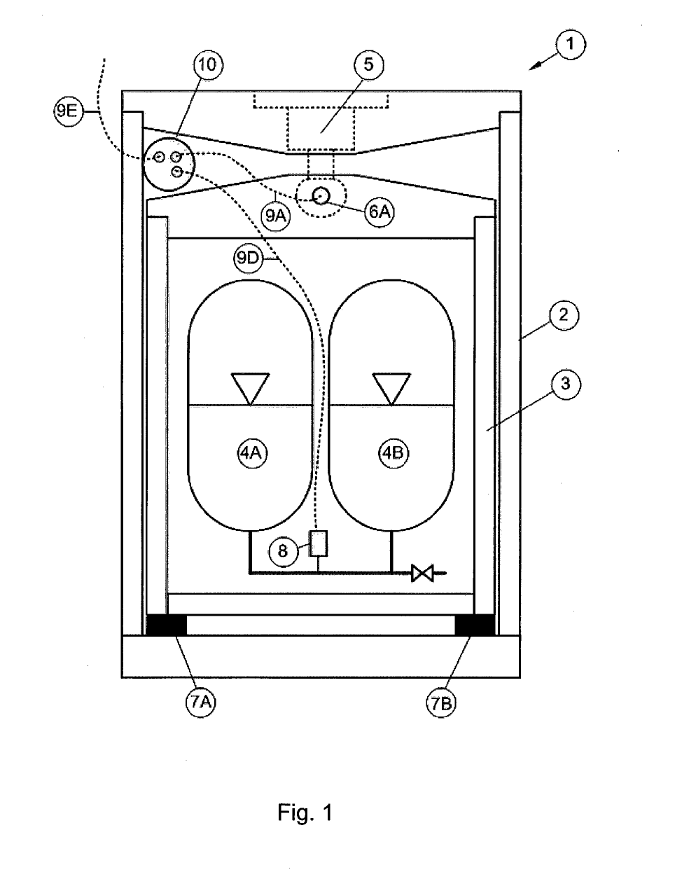

FIG. 1 shows a schematic side section of a first embodiment of an accumulator module, in which an inner structure is connected to a hydraulic cylinder via a load pin; and

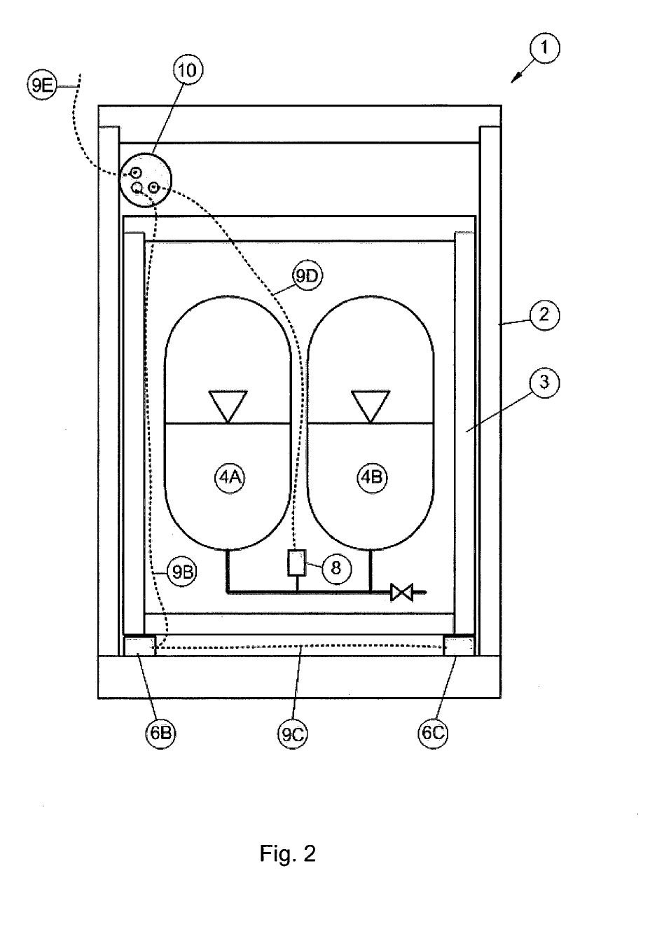

FIG. 2 shows a schematic side section of a second embodiment of an accumulator module, in which the inner structure is placed on load cells.

In the figures, the reference numeral 1 indicates an accumulator module with an outer structure 2 and an internal frame 3 provided with hydraulic accumulators 4A, 4B. The arrangement may be included in a hydraulic system under water or on the surface. As an example, the accumulator module 1 may be mounted on underwater equipment which is arranged to be installed or pulled to the surface by means of a vessel (not shown). In a first embodiment (see FIG. 1), the frame 3 with the accumulators 4A, 4B is suspended on a hydraulic cylinder 5 which is anchored to the top of the outer structure 2. The weight of the frame 3 with the accumulators 4A, 4B is registered with a load pin 6A forming a coupling between the hydraulic cylinder 5 and the frame 3. To avoid dynamic load on the load pin 6A in connection with handling the accumulator module 1, or equipment on which the module is mounted, the frame 3 is arranged, by means of the hydraulic cylinder 5, to be lowered, so that when being handled, the frame 5 rests on damping devices 7A, 7B arranged between the outer structure 2 and the frame 3.

The accumulator module 1 is provided with a data-logging system 8 which is arranged to register hydraulic working pressure, ambient pressure in underwater applications, and also store a relevant operational history for the accumulators 4A, 4B. Signal-communicating wires 9A, 9D respectively connect the load pin 6A and the data-logging system 8 to a communication unit 10 which is connected to a control system (not shown) via a signal-communicating wire 9E.

The data-logging system 8 is typically sealed to ensure that it cannot be disconnected. The software of the data-logging system 8 will be arranged to calculate the gas volume on the basis of the measured values of weight and working pressure. For accumulators 4A, 4B that are operated under water, buoyancy is taken into account. When several accumulators 4A, 4B are weighed together, it is not possible to know which accumulator 4A, 4B has possibly had a loss of gas, but there is control of the joint accumulator capacity. Any registered leakage of gas from one or more accumulators is accompanied by an alarm function.

In FIG. 2, an alternative arrangement is shown, which differs from the solution according to FIG. 1 by load cells 6B, 6C arranged on the outer structure 2 being used to weigh the frame 3 with the accumulators 4A, 4B. The load cells 6B, 6C are connected to the communication unit 10 via signal-communicating wires 9B, 9C. To possibly relieve the load cells 6B, 6C during handling of the accumulator module 1, or equipment on which the accumulator 1 is mounted, it is relevant to use hydraulic cylinders (not shown) to lift the frame. Alternatively, this may be solved through a mechanical arrangement (not shown).

1. A method of condition-monitoring hydraulic accumulators wherein the gas content of the accumulators is monitored by the gas volume being calculated on the basis of the weight and working pressure of the accumulators, and that data for the working pressure of the accumulators and a relevant operational history are collected and stored by means of an electronic logging system.
